(19) United States
(12) Patent Application Publication
(10) Pub. No.: US 2022/0121505 A1
(43) Pub. Date: Apr. 21, 2022

(54) PROFILING CLIPBOARD DATA IN A COMPUTING ENVIRONMENT

(71) Applicant: VMWARE, INC., Palo Alto, CA (US)

(72) Inventors: Rohit Pradeep Shetty, Bangalore (IN); Sharun Varghese Samuel, Bangalore (IN)

(21) Appl. No.: 17/134,135

(22) Filed: Dec. 24, 2020

(30) Foreign Application Priority Data
Oct. 15, 2020 (IN) 202041044912

(51) Int. Cl. G06F 9/54; G06F 9/455; G06F 8/36

(52) U.S. Cl. CPC G06F 9/543; G06F 8/36; G06F 9/45529

(57) ABSTRACT

Disclosed are various approaches for profiling data that is copied by a user. Additionally, approaches for profiling an input field into which the data is being pasted are also disclosed. Should a mismatch between the data that is being copied and an input field be detected, a warning user interface element can be shown to the user before the data is pasted.

### RELATED APPLICATIONS

Benefit is claimed under 35 U.S.C. 119(a)-(d) to Foreign Application Ser. No. 202041044912 filed in India entitled “PROFILING CLIPBOARD DATA IN A COMPUTING ENVIRONMENT”, on Oct. 15, 2020, by VMware, Inc., which is herein incorporated in its entirety by reference for all purposes.

### BACKGROUND

In modern computing environments, the browser is one of the most-used applications on mobile or desktop environments. Browser based apps and services are often used for various purposes, such as enterprise, personal, financial, or other purposes. Additionally, copy in data to and pasting data from a clipboard provided by an operating system is a key productivity and convenience that almost all users in modern computing environments utilize for various reasons. For example, users might copy a username or password from a document or application and paste it into a login field. Users might copy and paste uniform resource locators (URLs) into a browser address bar. Users might also copy and paste text of any type to reduce or eliminate the need to type or links with other users for various reasons. However, users might inadvertently paste potentially sensitive or confidential content into an application or form that is untrusted or malicious.

Therefore, users or enterprises can create policies that ask users to be cognizant and careful about pasting content into an application or form, such as a form on a web page. However, without programmatic enforcement of such a policy, the risk of information leaking to malicious actors or sites still exists.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, n the drawings, like reference numerals designate corresponding parts throughout the several views.

FIG. 1 is an example browser user interface according to various examples of the disclosure.

FIG. 2 is an example browser user interface according to various examples of the disclosure,

FIG. 3 is an example browser user interface according to various examples of the disclosure.

FIG. 4 is an example browser user interlace according to various examples of the disclosure.

FIG. 5 is a drawing of a computing device according to various examples of the disclosure.

FIG. 6 is a flowchart that illustrates functionality according to an example of the disclosure.

FIG. 7 is a flowchart that lustrates functionality according to an example of the disclosure.

### DETAILED DESCRIPTION

Disclosed are examples of a framework that reduces the likelihood of information leakage through the pasting of sensitive information into malicious sites or forms. In modern computing environments, network accessible applications are used in an enterprise setting for various reasons. Additionally, browser-based applications are used to perform tasks by users that might involve sensitive or confidential information, such as passwords, sensitive or confidential corporate data, personal information, or other information that the enterprise might wish to keep out of the hands of malicious actors.

Malicious actors in a connected environment may try to obtain sensitive information in various ways. In addition to brute force methods of cracking or obtaining sensitive and potentially valuable data, a malicious actor might utilize social engineering or phishing attacks that cause a user to inadvertently enter sensitive or confidential data into a form on a website rendered by a browser. In this scenario, the user might inadvertently copy sensitive information from a first source and paste the information into a form that transmits the sensitive information to the malicious actor. In some instances, an input field on a page of a malicious actor might transmit information entered into the field without the user even submitting a form in which the field is placed.

Therefore, examples of this disclosure provide a mechanism by which the user can be warned or even stopped from entering potentially sensitive information into a field or form that is displayed by an application such as a browser. examples of the disclosure can operate by utilizing an SDK library that is embedded into applications that are created with a particular SDK library that provides the functionality described herein. For example, a browser can be created utilizing the SDK library that has the capability to profile data that is copied to a clipboard of a computing environment. Additionally, the SDK library can profile a field or form into which the user is attempting to paste data.

The SDK library can be instrumented too detect a mismatch between the context of data that is copied onto a clipboard or the data itself and the context into which the user attempts to paste the data. The context of the data that is copied onto a clipboard can include a data source from which the data is copied, data that is near or around the data being copied, or aspects of the data itself. For example, the context of the data that is copied can include an application or document from which the data is copied. The context of the destination into which a user is attempting to paste the data can include aspects or tags that might surround an input field into which the user is attempting to paste the copied data.

For example, examples of the disclosure can determined that a mismatch between the context of data being copied and the destination into which the data is attempting to be pasted by detecting that the data being copied is a password and that the context into which the data is being pasted is a malicious site or that the input field into which the data is being pasted is not a password field. When such a mismatch is detected, examples of the disclosure can generate a warning that is displayed to the user or prevent the user from completing the operation of pasting the data into the attempted destination.

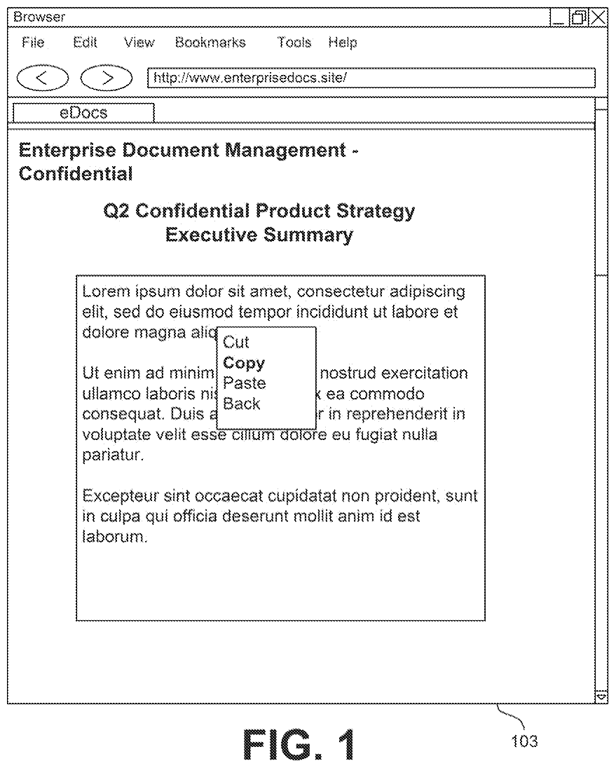

Referring next to FIG. 1 shown is an example scenario according to one example of the disclosure. As shown in FIG. 1, a browser application can be utilized by the user of a computing device. The browser can be used to access various sites for personal or enterprise purposes. For example, the enterprise might provide a time entry system for users to track their hours for compensation purposes. As another example, the enterprise can provide a human resources application that is accessible using the browser through which human resources professionals, employees, and contractors can access and exchange potentially sensitive or private human resources information for the enterprise. As another example, a browser-accessible source code repository might be utilized by the enterprise for software engineers and developers to manage or access a source code repository.

However, a browser application can also have non-enterprise uses. Users might browse the internet to access news, games, and other information. An enterprise often allows their users to do so using an enterprise-issued device. In some instances, information technology administrators might require or encourage users to use a particular browser application.

In the example of FIG. 1, an application 103 is shown that is a browser instrumented to profile copied data. The browser can be made using a software development kit (SDK) or a library that allows the browse to be created with the capability to profile data copied to the clipboard of an operating system on which the browser is running. As shown in FIG. 1, the user can copy text to the operating system clipboard. Accordingly, the application 103 with clipboard profiling capability can generate a profile of the data that is being copied as well as the context from which the data is being copied. For example, if the user copies a snippet of text from the displayed page, the application 103 can identify a broader context of the page in which the snippet is included, such as a document header, datatypes, title, and embedded tags or metadata in the page. In the example of FIG. 1, the document header can be a part of the context that is included in the profile of the text that is being copied. Tags that described this context can be stored in the profile of the copied data. The profile of the copied data can be stored by the application 103 in memory or n a local data store accessible to the application 103. In some instances, the copied data can also be stored along with the profile.

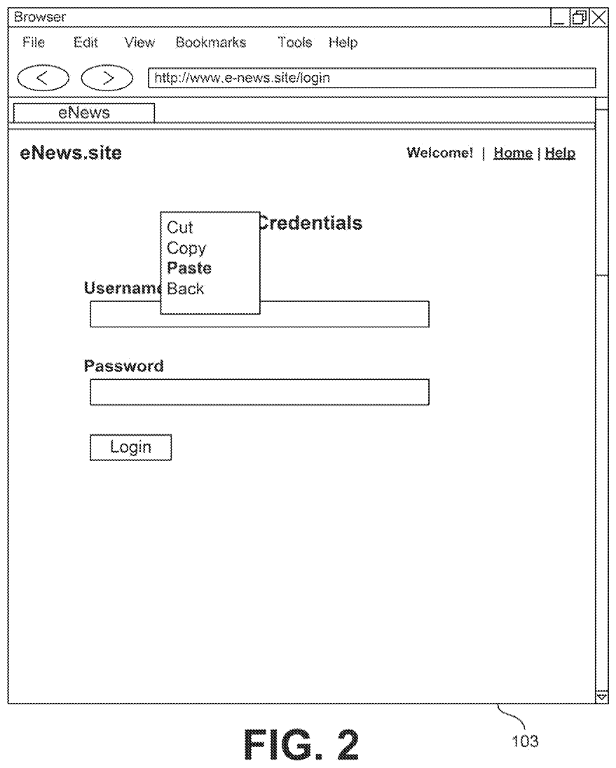

The profile can be utilized to assess whether the copied data, when pasted, should be pasted into a given field, document, or destination if or when the user attempts to paste the content. Accordingly, reference is now made to FIG. 2, which continues the example of FIG. 1. In FIG. 2, the user has navigated to a different page within the application 103. The different page can be provided by a different site that might not be for an enterprise purpose. For example, the user might browse to a news website or another website on the internet. In one scenario, the site shown in FIG. 2 can provide a page that includes one or more input fields.

In one scenario, the user might attempt to paste data into an input field, believing that the last item copied to the clipboard is the appropriate data for the input field, such as a username input field. Accordingly, the application 103, before completing the operation to paste the data from the clipboard into the input field, can generate a profile for the input field and the context. The profile for the input field can include parameter names in markup tags associated with the input field, a uniform resource locator (URL) for the site, text and images surrounding the input field and other data that can be extracted from the page.

If the application 103 detects a mismatch between the profile of the copied data and the input field into the data is being pasted, various remedial actions can be taken. In one example, a remedial action can include generating a warning to the user before pasting the data to the input field. In another example, the application 103 can prevent or disallow the data from being pasted to the input field.

A mismatch between the profile of the copied data and the input field can be detected in various ways. For example, the application 103 can detect that the data type of the copied data is different from the data type of the input field. As one scenario, the data type of the copied data might be a “username” and the data type of the copied data might be a “password.” In some cases, an application 103 can institute a policy that prevents copying or pasting of data to or from a password field. A mismatch can also be detected by determining that the copied data in the clipboard represents non-text data but the input field is a textbox.

As another example of mismatch detection, a mismatch can be detected by determining that the data was copied from a particular type of application and that the data is being pasted into a different type of application. For example, multiple types of applications can be created with the ability to profile data that is being copied or pasted by user. Accordingly, the application 103 can include at tag that identifies its type or the application by name. When the data is being pasted into an input field into a different application 103, a mismatch can be detected. In some instances, a mismatch can be detected by determining that the copied data is not formatted appropriately for the type of input field. For example, an input field might be formatted to reject inputs that have certain characters or be formatted as a password field. If the copied data does not comply with the formatting requirements of the input field, a mismatch can be detected. For example, the copied text might include special characters or numbers indicating the possibility that it is a password, but the input field might be formatted as a comment box or to receive and validate an email address.

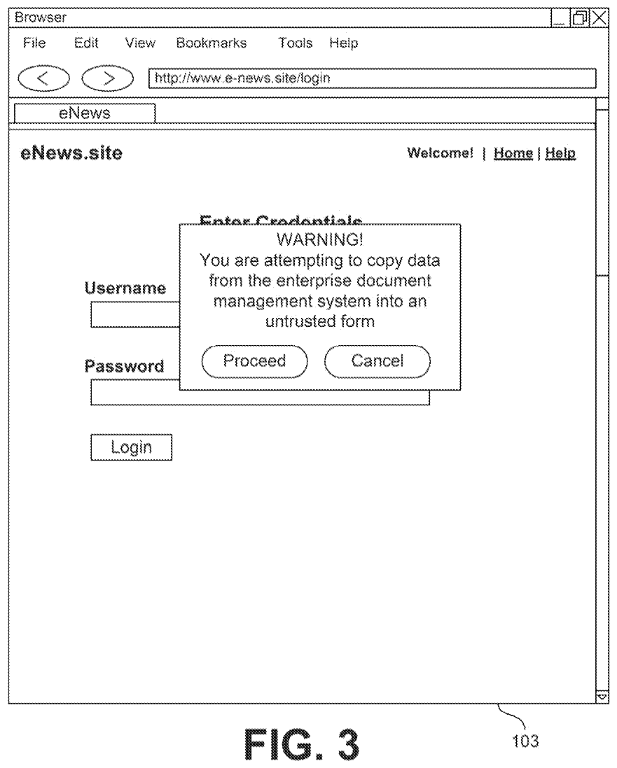

Referring next to FIG. 3, shown is an example of how the application 103 can issue a warning to the user in response to detecting a mismatch between the profile of the copied data and the input field into which the data is being pasted. In the example of FIG. 3, the application 103 can intercept the data being copied, determine if a mismatch between the copied data and the input field exists, and display a warning user interface element before completing the operation of pasting the data into the input field. In the example of FIG. 3, the application 103 warns the user that the data that was copied is being pasted into a form that is untrusted. Trust can be established by a website whitelist created by an administrator, as one example. The whitelist can also indicate that data copied from a particular application, such as an enterprise document management system, requires a warning no matter where the data is attempted to be pasted by the user.

The user interface element can be overridden by a user or in some instances, certain data that is profiled can be prevented from being pasted into another application no matter the reason or based on a rules hierarchy established by a user or an administrator of the computing device. For example, a rules engine can determine that passwords are never permitted to be pasted or that passwords or other types of sensitive data that, if identified when the user copies the data, cannot even be copied to an operating system clipboard.

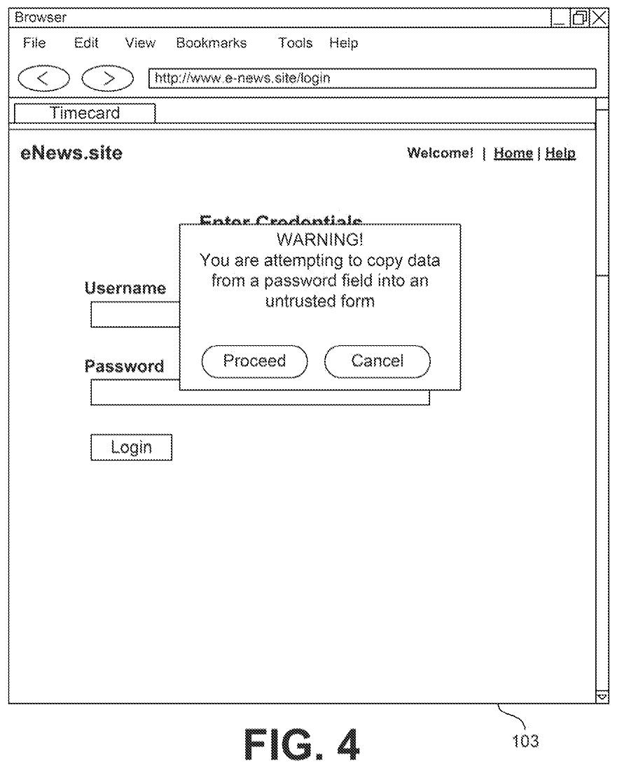

Referring next to FIG. 4, shown is an example of ow the application 103 can issue a warning to the user in response to detecting a mismatch between the profile of the copied data and the input field into which the data is being pasted. In the example of FIG. 3, the application 103 can intercept the data being copied, determine if a mismatch between the copied data and the input field exists, and display a warning user interface element before completing the operation of pasting the data into the input field. In the example of FIG. 3, the application 103 warns the user that the data that was copied was profiled as a password based upon the context of the location from which the data was copied. The user interface element also warns the user that the input field into which the data is being pasted into a form that is untrusted.

The user interface element can be overridden by a user or in some instances, certain data that is profiled can be prevented from being pasted into another application no matter the reason or based on a rules hierarchy established by a user or an administrator of the computing device For example, a rules engine can determine that passwords are never permitted to be pasted or that passwords or other types of sensitive data that, if identified when the user copies the data, cannot even be copied to an operating system cupboard.

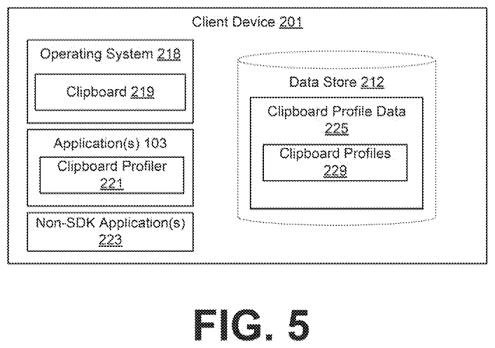

FIG. 5 illustrates an example of certain elements of as environment that includes a client device 201 according to one example of the disclosure. The client device 201 can represent a computing device that can implement examples of the disclosure. A computing device can include, for example, a processor-based computer system. According to various examples, a computing device can be in the form of a desktop computer, a laptop computer, a personal digital assistant, a mobile phone, a smartphone, or a tablet computer system. The computing device can be coupled to or have a display on which a user interface associated with the application 103 and potentially other applications can be rendered. In the context of this disclosure, an application 103 can be one that is created with an SDK library that can profile data that is copied to an operating system clipboard and pasted from the clipboard. Accordingly, an application 103 can be instrumented with a clipboard profiler 221, which can implement the functionality described herein.

The clipboard profiler 221 can implement the copying and pasting feature of an application 103. The clipboard profiler 221 can add additional features to the copying and pasting feature of the application 103 while remaining compatible with operating system guidelines that specify how copying and pasting data should be performed for application interoperability reasons. The features provided by the clipboard profiler 221 are described in further detail herein.

The client device 201 can also execute an operating system 218. The operating system 218 can be a mobile or desktop operating system that can provide copy/paste functionality, which is also referred as a clipboard or operating system clipboard. The operating system 218 can maintain a clipboard 219. The clipboard 219 can represent a storage location or in-memory location that is maintained by the operating system 218 to storage and retrieving data that is copied and pasted by applications that are running on the client device 201. The clipboard 219 can be maintained in a mass storage resource of the client device 201 in some implementations.

The operating system 218 can also manage interactions between software on the client device 201 and other hardware components, such as display devices, input/output devices, graphics processing units (GPUs), central processing units, and other hardware capabilities of the client device 201. The operating system 218 can also allow other types of applications to be executed that are not instrumented with the clipboard profiler 221. In the context of this disclosure, these applications are referred to a non-SDK application 223. A non-SDK application 223 is any application that can be installed on the client device 201 that is not instrumented with the clipboard profiler 221 functionality that profiles data that is attempted to be copied from and/or pasted to the clipboard provided by the operating system 218. Additionally, a non-SDK application 223 is also unable to generate a warning user interface element when a mi etch between a profile for copied data and pasted data is detected.

An application 103 with the clipboard profiler 221, such as a browser application can retrieve and render content pages, such as web pages. In some examples, the content pages cart be retrieved over a network connection and/or include hyperlinks to other network pages, input fields into which data can be entered, and other information. An application 103 with the clipboard profiler 221 can also include a text, image, or video editing platform a document management system, a development environment, a messaging application, email client, or any other application 103 that can be utilized by a user and that can be created using an SDK or other mechanism that allows the functionality of the clipboard profiler 221 to be incorporated into the application 103.

In one implementation, the clipboard profiler 221 can be implemented as an extension or plugin that can extend the functionality of the application 103 and the content that can be rendered within the application 103. For example, a browser plugin can implement the functionality of the clipboard profiler 221. Additionally, the application 103 can have an additional runtime environment, such as Java, that can execute code that can also extend the functionality of the application 103 to implement the functionality of the clipboard profiler 221. The clipboard profiler 221 can also be implemented using client-side executable code that is injected into a content page being rendered by an application 103. For example, the clipboard profiler 221, or at least a portion of the clipboard profiler 221 that generates a warning user interface element, can be implemented using Javascript code that is executed by a browser application.

The client device 201 can include a data store 212 in which data that can be accessed by an application 103 or a non-SDK application 223 that is installed on the client device 201. The data store 212 can represent mass storage, flash memory, volatile memory, or other storage resources provided by the client device 201 for use by an application 103 or non-SDK application 223. The data store 212 can include storage areas that are specific or private to the certain applications that are installed on the client device 201. Additionally, certain storage areas can be private to applications that are signed by a particular developer certificate so that multiple applications created by a common developer can have access to a common storage area that is private to the applications that are signed by the same developer certificate.

In the data store 212, one or more application 103 implementing the clipboard profiler 221 can store and/or access clipboard profile data 225. The clipboard profile data 225 can include information about data that is copied to the operating system clipboard 219. Clipboard profile data 225 can include a clipboard profile 229 for data copied to the clipboard. A clipboard profile 229 can also exist for input fields that are profiled by the clipboard profiler 221 before data is pasted to the input field.

As described herein, the clipboard profiler 221 implemented by an application 103 can create a profile for data copied to the clipboard 219. When an application 103 detects an attempt to copy data to the clipboard 219, the clipboard profiler 221 can be invoked to generate a profile for the data that is being copied as well as the context of the copied data. The profile can include the data itself as well as information about the application 103 and the data and/or fields that surround the copied data. The profile can be saved as a clipboard profile 229 so that an application 103 that includes the functionality of the clipboard profiler 221 can consult the clipboard profile 229 to determine whether to paste the copied data or generate a warning user interface element that warns the user about pasting data into an input field that constitutes a potential mismatch between the context from which is was copied and the context of the input field.

To profile the context of copied data or an input field, the clipboard profiler 221 in the case of a page with markup language, can analyze an immediate parent element of an input field for more information. Web pages or other content that include XML-based markup language are designed in a hierarchical manner. Accordingly, the clipboard profiler 221 can analyze a document object model (DOM) tree that the application 103 generates when rendering a page. Accordingly, the clipboard profiler 221 can parse the elements and/or parameters of an HTML element containing the input field until it finds relevant information to create a profile for the input field. The information that is identified in the fields defining input field and its parent elements can be included in a clipboard profile 229 for the input field,

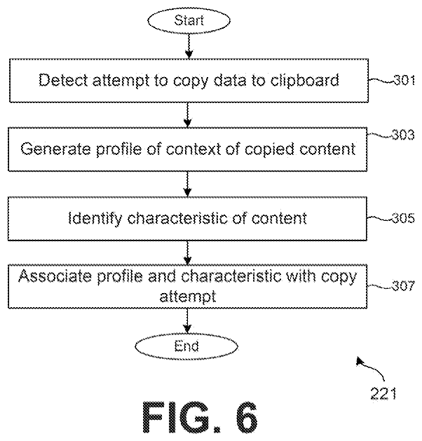

Referring next to FIG. 6, shown is a flowchart and illustrates functionality of the application 103 implementing the according to an example of the disclosure. The functionality illustrated in FIG. 6 can also be provided by an extension or plugin. In other examples, the functionality illustrated in FIG. 6 can also be provided natively within the application 103. Although the flowchart is discussed with respect to being performed within the clipboard profiler 221 of the application 103, the functionality can also be implemented using a different architecture.

First, at step 301, the clipboard profiler 221 can detect an attempt to copy data to the clipboard 219. The clipboard profiler 221 can detect the attempt because the application 103 can incorporate the functionality of the clipboard profiler 221 using an SDK library, an extension, or a plug-in. The clipboard profiler 221 can implement the feature of the application 103 that copies data to the clipboard 219 of the operating system 218. The clipboard profiler 221 can generate a profile of the data that the user is attempting to copy to the clipboard 219. The clipboard profiler 221 can generate the profile by identifying the data as well as contextual information that surrounds the data that is being copied.

Next, at step 303, the clipboard profiler 221 can generate the profile of the copied data and the context from which it is copied. The profile can be generated prior to, after, or contemporaneously with the data being provided to the clipboard 219 maintained by the operating system 218. The clipboard profile 229 can include the data itself or a hash or the copied data so that when the data is attempted to be pasted, the clipboard profiler 221 can identify the appropriate clipboard profile 229 in the clipboard profile data 225.

The clipboard profiler 221 can determine whether the copied data corresponds to potentially sensitive or private enterprise data by searching the data and the context from which the data was copied, such as the text and fields surrounding the copied data, for keywords that indicate that the data is sensitive. For example, referring back to the example of FIG. 1, the clipboard profiler 221 can determine that the text the user attempting to copy is potentially confidential or sensitive by identifying the keyword “Confidential” in the document surrounding the copied text. As another example, if the context of the copied data contains the word “password,” the clipboard profiler 221 can determine that the copied data potentially represents a password and is potentially confidential or sensitive.

In some cases, the clipboard profiler 221 can determine that the copied data represents sensitive or confidential based upon the identity or type of the application 103 from which the data is being copied. For example, if the application 103 is a document management application, a source code repository, or a development environment that users utilize to access priority or confidential information, the clipboard profiler 221 can determine that any data copied from these applications is potentially sensitive or confidential.

As another example, in the case of an application 103 that s a browser, the clipboard profiler 221 can determine that the data being copied is potentially sensitive or confidential based upon a site address of a page from which the data is being copied. For example, the clipboard profiler 221 can be configured to designate certain website domains as containing confidential or sensitive information so that all data copied from those sites is associated with a clipboard profile 229 that indicates that the data is potentially confidential or sensitive.

Accordingly, in step 305, the clipboard profiler 221 can identify one or more characteristic of the data being copied as well as the context from which the data is being copied. The one or more characteristic can be added to the clipboard profile 229 that is associated with the copied data. A characteristic can include a data type of the copied data. For example, in the case of copied text, the characteristic can specify that the copied data is formatted as an email address, a mailing address, a proper name, a surname, a zip code, or another identifiable text characteristic. In the case of a copied image, the characteristic can specify that the copied data is an image as well as information that can be identified in the image after an image recognition analysis. The image recognition analysis can identify text attributes, objects, places, or people in the copied image and associated the identified attributes with the clipboard profile 229 that is generated for the copied content.

Next, at step 307, the clipboard profiler 221 can associate the clipboard profile 229 that is generated for the copied content with the content. The clipboard profile 229 can be stored in the data store 212 in clipboard profile data 225. The clipboard profile 229 can be stored along with the data that is copied to the clipboard 219. In some implementations, the clipboard profile 229 can be kept in the clipboard profile data 225 even after another item is copied to the clipboard 219 and overwrites the most recently copied entry to the clipboard 219. Once the clipboard profile 229 is stored in the data store 212, the process can proceed to completion

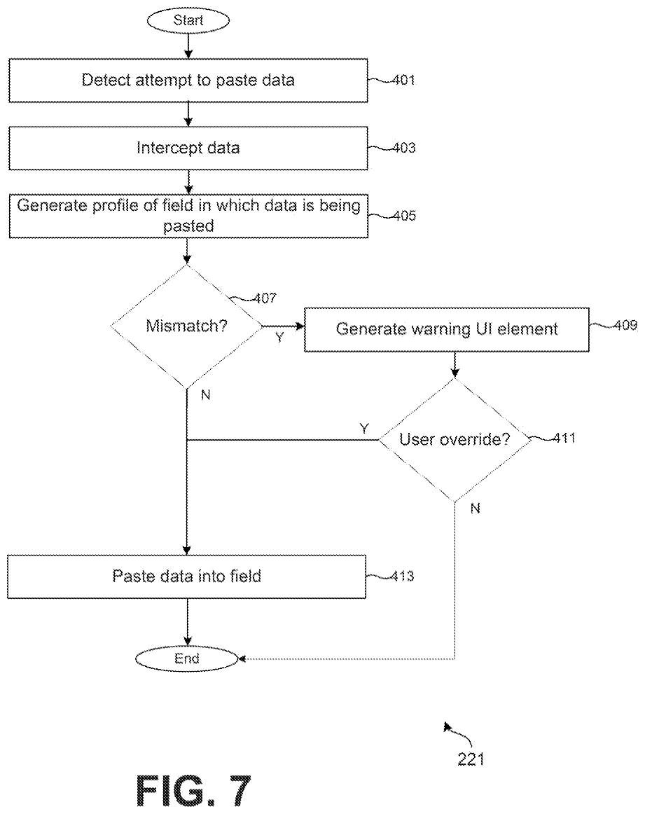

Referring next to FIG. 7, shown is a flowchart and illustrates functionality of the application 103 or the clipboard profiler 221 according to an example of the disclosure. Although the flowchart is discussed with respect to being performed within the application 103, the functionality can also be implemented by a browser extension or plug-in. FIG. 7 illustrates a process whereby the application 103 can profile an input field to which data is being pasted by a user to determine whether a warning user interface element should be displayed to the user before pasting the data into the input field.

At step 401, the application 103 can detect an attempt to paste data from the clipboard 219 into an input field. The clipboard profiler 221 can implement the feature of the application 103 that pastes data from the clipboard 219 provided by the operating system 218. The clipboard profiler 221 can detect the attempt to paste data by determining that the user has invoked or selected the paste function provided by the application 103. The input field can represent a field on a page rendered by a browser a form or into any input field on a user interface rendered by the application 103.

In some implementations, the application 103 can profile input fields in a page when the page is retrieved and/or rendered by the application 103. Rather than waiting until the user attempts to paste data from the clipboard 219 into an input field, the clipboard profiler 221 can preemptively profile the input fields in a page or screen of an application 103 and generate one or more clipboard profile 229 for the input fields. By preemptively profiling input fields, the clipboard profiler 221 can speed the operation of pasting data into an input field because a clipboard profile 229 is preemptively generated for a given input field before the user attempts to paste data from the clipboard 219.

At step 403, the clipboard profiler 221 can intercept the data that the user is attempting to paste into an input field. The clipboard profiler 221 can intercept the data by not yet causing the data from the clipboard 219 to be pasted into the input field requested by the user. As noted above, in one example, the clipboard profiler 221 can intercept the data by injecting client-side code into a browser page rendered by the application 103. In another example, the clipboard profiler 221 can intercept the data that the user attempts to paste via the browser engine itself. For example, the JavaScript calls can be intercepted at the browser engine and the data thus intercepted can be analyzed to create a clipboard profile 229.

At step 405, the clipboard profiler 221 can generate a profile of the input field into which the user is attempting to paste an item from the clipboard 219. The profile can be a clipboard profile 229 that can be based on an analysis of the input field as well as the context surrounding the input field. The clipboard profiler 221 can analyze parameters associated with one or more tags that define an input field and associate the parameter names and/or parameter values with the clipboard profile 229 corresponding to the input field. For example, in a page rendered by a browser, one or more markup language tags can be used to define the input field and also be located in proximity to the input field in the markup language that defines the page. In this scenario, the clipboard profiler 221 can associate the parameter names or parameter values with the clipboard profile 229 for the input field.

For example, if a parameter name is defined as “username,” the clipboard profiler 221 can deduce that the input field is configured to accept a username input. An input field that is defined as a password field can be deduced to accept a password input. Similarly, an input field that is associated with a textual or descriptive parameter can be profiled as an input field that is defined by the descriptive parameter.

As another example, a content type can be associated with the clipboard profile 229. For example, if the input field is identified as a text input field, the content type associated with the clipboard profile 229 can be a text field. Additionally, if the input field has certain formatting requirements, the formatting requirements can be associated with the clipboard profile 229 for the input field.

In some implementations, the clipboard profile 229 can be generated using client-side code, such as JavaScript code, that is injected into a content page rendered by the application 103, such as a browser application. The client-side code can be executed by the application 103 and generate a warning user interface element if a mismatch between the copied data and the input field is identified as described in steps 407 and 409.

At step 407, after generating the clipboard profile 229 for the input field, the clipboard profiler 221 can determine whether a mismatch exists between the clipboard profile 229 corresponding to the copied content and the clipboard profile 229 of the input field to which the user is attempting to paste the content. Accordingly, the clipboard profiler 221 can retrieve the clipboard profile 229 corresponding to the content on the clipboard 219 and the input field.

A mismatch can be identified in various manners. As one example, the clipboard profiler 221 can identify a mismatch if a descriptive tag associated with the input field differs from a type identified for the copied content. If the copied content has been identified as a username but the clipboard profile 229 for the input specifies that the input field is a password field, the clipboard profiler 221 can identify a mismatch.

As another example, if the copied content was copied from an application 103 that is designated to contain sensitive or confidential information, the clipboard profiler 221 can identify a mismatch whenever content copied from the application 103 is pasted into a different application 103.

A mismatch can also be detected whenever the content type associated with the content differs from a content type identified for the input field and defined by its respective clipboard profile 229. A mismatch can also be detected whenever the copied content does not comply with formatting requirements identified by the clipboard profile 229 for the input field. For example, if the formatting requirements for an input field specify that the field accepts a properly formatted email address, the clipboard profiler 221 can identify a mismatch if the copied content is not formatted as an email address. As another example, if the input field specifies that the field should be formatted as a password with complexity requirements, the clipboard profiler 221 can identify a mismatch if the copied content does not meet the complexity requirements.

As another example, a mismatch can be identified if a type associated with the input field is indeterminate, or the type cannot be determined. The clipboard profiler 221 can determine that an indeterminate type for an input field can be an indication of a malicious input field that is attempting to hides its true purpose. If a mismatch is identified at step 407, the process can proceed to step 409. If no mismatch is identified at step 407, the process proceeds to step 413.

At step 409, the clipboard profiler 221 can generate a warning user interface element. The warning user interface element can warn the user about the mismatch between the copied content and the input field into which the user is attempting to paste the content. The warning user interface element can be generated before the content is pasted by the clipboard profiler 221 into the input field.

At step 411, the clipboard profiler 221 can determine whether the user overrides the warning user interface element to force the clipboard profiler 221 to paste the content into the input field. In some implementations, the clipboard profile 229 of the copied content can specified that user overriding of the warning user interface element is not permitted. For example, certain copied data can be deemed to be too sensitive to permit user overriding. This can be specified for content copied from a certain application 103 or of a particular data type. If the user does not override the warning user interface element or if user overriding is not permitted, the process can proceed to completion without the content being pasted into the input field. If the user overrides the warning user interface element, the process proceeds to step 413.

At step 413, the clipboard profiler 221 can cause the content from the clipboard 219 to be pasted into the input field. Thereafter, the process can proceed to completion.

The flowcharts of FIGS. 6-7 show an example of the functionality and operation herein can be embodied in hardware, software, or a combination of hardware and software. If embodied in software, each element can represent a module of code or a portion of code that includes program instructions to implement the specified logical function(s). The program instructions can be embodied in the form of source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

Although the flowcharts of FIGS. 6-7 show a specific order of execution, it is understood that the order of execution can differ from that which is shown. The order of execution of two or more elements can be switched relative to the order shown. Also, two or more elements shown in succession can be executed concurrently or with partial concurrence,. Further, in some examples, one or more of the elements shown in the flowcharts can be skipped or omitted. In addition, any number of counters, state variables, warning semaphores, or messages could be added to the logical flow described herein, for purposes of enhanced utility, accounting, performance measurement, or troubleshooting aid. It is understood that all such variations are within the scope of the present disclosure.

The client device 201 can include at least one processing circuit. The processing circuit can include one or more processors and one or more storage devices that are coupled to a local interface. The local interface can include a data bus with an accompanying address/control bus or any other suitable bus structure. The one or more storage devices for a processing circuit can store data or components that are executable by the one or processors of the processing circuit. Also, a data store can be stored in the one or more storage devices.

The application 103 and other components described herein can be embodied in the form of hardware, as software components that are executable by hardware, or as a combination of software and hardware. If embodied as hardware, the components described herein can be implemented as a circuit or state machine that employs any suitable hardware technology. The hardware technology can include one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that includes software or program instructions can be embodied in any non-transitory computer-readable medium for use by or in connection with an instruction execution system such as a processor in a computer system or other system. The computer-readable medium can contain, store, or maintain the software or program instructions for use by or in connection with the instruction execution system.

The computer-readable medium can include physical media, such as, magnetic, optical, semiconductor, or other suitable media. Examples of a suitable computer-readable media include, but are not limited to, solid-state drives, magnetic drives, flash memory. Further, any logic or component described herein can be implemented and structured in a variety of ways. One or more components described can be implemented as modules or components of a single application. Further, one or more components described herein can be executed in one computing device or by using multiple computing devices.

it is emphasized that the above-described examples of the present disclosure are merely examples of implementations to set forth for a clear understanding of the principles of the disclosure. Many variations and modifications can be made to the above-described examples without departing substantially from the spirit and principles of the disclosure,. AU of these modifications and variations are intended to be included herein within the scope of this disclosure.

What is claimed is:

1. A system comprising:
a computing device comprising a processor and a memory, the computing device executing at least one application, wherein the at least one application is configured to at least:
detect an attempt to copy content in the at least one application to a clipboard accessible by applications installed on the computing device;
generate a first profile of a context of the content;
identify at least one characteristic of the content;
detect an attempt to paste the content into a field;
generate a second profile of the field;
identify a mismatch between the first profile and e second profile; and
generate a warning user interface element that restricts the content from being pasted into the field.

2. The system of claim 1, wherein the at least one application comprises a first application associated with the context of the content and a second application associated with the field, wherein a common software development kit (SDK) is used to build the first application and the second application.

3. The system of claim 1, wherein the at least one application comprises a browser application, and the browser application is configured to at least:
identify a first parameter associated with a tag defining an input field corresponding to the context of the content;
identify a second parameter associated with the field corresponding to the attempt to paste; and
determine that a data type of the input field does not match the field corresponding to the attempt to paste based upon respective descriptive text corresponding to the first parameter and the second parameter.

4. The system of claim 1, wherein the at least one application comprises a browser application, and the browser application identifies the mismatch between the first profile and the second profile by injecting client-side code into a page in which the field is rendered.

5. The system of claim 4, wherein the client-side code comprises JavaScript code that generates the second profile of the field based upon at least one markup language tag associated with the field.

6. The system of claim 4, wherein the client-side code intercepts the content and restricts the content from being entered into the field.

7. The system of claim 1, wherein the at least one application detects the mismatch by determining that a type associated with the field is indeterminate,

8. A method comprising:
detecting an attempt to copy content in at least one application to a clipboard accessible by applications installed on a computing device;
generating a first profile of a context of the content;
identifying at least one characteristic of the content;
detecting an attempt to paste the content into a field;
generating a second profile of the field;
identifying a mismatch between the first profile and the second profile; and
generating a warning user interface element that restricts the content from being pasted into the field.

9. The method of claim 8, wherein the at least one application comprises a first application associated with the context of the content and a second application associated with the field, wherein a common software development kit (SDK) is used to build the first application and the second application.

10. The method of claim 8, wherein the at least one application comprises a browser application, and the method further comprises:
identifying a first parameter associated with a tag defining an input field corresponding to the context of the content;
identifying a second parameter associated with the field corresponding to the attempt to paste; and
determining that a data type of the input field does not match the field corresponding to the attempt to paste based upon respective descriptive text corresponding to the first parameter and the second parameter.

11. The method of claim 8, wherein the at least one application comprises a browser application, and the browser application identifies the mismatch between the first profile and the second profile by injecting client-side code into a page in which the field is rendered.

12. The method of claim 11, wherein the client-side code comprises JavaScript code that generates the second profile of the field based upon at least one markup language tag associated with the field,

13. The method of claim 11, wherein the client-side code intercepts the content and restricts the content from being entered into the field.

14. The method of claim 8, wherein the at least one application detects the mismatch by determining that a type associated with the field is indeterminate.

15. A non-transitory compute readable medium comprising machine-readable instructions comprising:
detect an attempt to copy content in at least one application to a clipboard accessible by applications installed on a computing device;
generate a first profile of a context of the content;
identify at least one characteristic of the content;
detect an attempt to paste the content into a field;
generate a second profile of the field;
identify a match between the first profile and the second profile; and
generate a warning user interface element that restricts the content from being pasted into the field.

16. The non-transitory computer-readable medium of claim 15, wherein the at least one application comprises a first application associated with the context of the content and a second application associated with the field, wherein a common software development kit (SDK) is used to build the first application and the second application.

17. The non-transitory computer-readable medium of claim 15, wherein the at least one application comprises a browser application, and the browser application is configured to at least:
identify a first parameter associated with a tag defining an input field corresponding to the context of the content;
identify a second parameter associated with the field corresponding to the attempt to paste; and
determine that a data type of the input field does not match the field corresponding to the attempt to paste based upon respective descriptive text corresponding to the first parameter and the second parameter.

18. The non-transitory computer-readable medium of claim 17, wherein the at least one application comprises a browser application, and the browser application identifies the mismatch between the first profile and the second profile by injecting client-side code into a page in which the field is rendered.

19. The non-transitory computer-readable medium of claim 15, wherein the at least one application comprises a browser application, and the browser application identifies the mismatch between the first profile and the second profile by injecting client-side code into a page in which the field is rendered.

20. The non-transitory compute readable medium of claim 19, wherein the client-side code comprises JavaScript code that generates the second profile of the field based upon at least one markup language tag associated with the field.
